(19) United States
(12) Patent Application Publication
(10) Pub. No.: US 2026/0292828 A1
(43) Pub. Date: Sep. 24, 2026

(54) SEQUENCE-BASED INDICATOR FOR UPLINK TRANSMISSION

(71) Applicant: QUALCOMM Incorporated, San Diego, CA (US)

(72) Inventors: Raviteja PATCHAVA, San Diego, CA (US); Jing SUN, San Diego, CA (US); Jing JIANG, San Diego, CA (US)

(21) Appl. No.: 19/085,232

(22) Filed: Mar. 20, 2025

(51) Int. Cl. H04W 72/21; H04L 1/00; H04L 5/00

(52) U.S. Cl. CPC H04W 72/21; H04L 1/0003; H04L 5/0005

(57) ABSTRACT

Various aspects of the present disclosure generally relate to wireless communication. In some aspects, a user equipment (UE) may receive a resource pool configuration for physical uplink shared channel (PUSCH) resources and sequences for modulation and coding schemes (MCSs) and payload sizes. The UE may transmit a sequence that corresponds to a selected MCS and payload size. The UE may transmit a PUSCH message using a PUSCH resource and the selected MCS and payload size. Numerous other aspects are described.

### FIELD OF THE DISCLOSURE

Aspects of the present disclosure generally relate to wireless communication and specifically relate to techniques, apparatuses, and methods associated with a sequence-based indicator for uplink transmission.

### DESCRIPTION OF THE RELATED TECHNOLOGY

Wireless communication systems are widely deployed to provide various services, which may involve carrying or supporting voice, text, other messaging, video, data, or other traffic. Typical wireless communication systems may employ multiple-access radio access technologies (RATs) capable of supporting communication among multiple wireless communication devices including user devices or other devices by sharing the available system resources (for example, time domain resources, frequency domain resources, spatial domain resources, or device transmit power, among other examples). Such multiple-access RATs are supported by technological advancements that have been adopted in various telecommunication standards, which define common protocols that enable different wireless communication devices to communicate on a local, municipal, national, regional, or global level. An example telecommunication standard is New Radio (NR). NR, which also may be referred to as 5G, is part of a continuous mobile broadband evolution promulgated by the Third Generation Partnership Project (3GPP). As the demand for connectivity continues to increase, further improvements in NR may be implemented, and other RATs, such as 6G and beyond, may be introduced to enable new applications and facilitate new use cases.

### SUMMARY

Some aspects described herein relate to a method of wireless communication performed by a user equipment (UE). The method may include receiving a resource pool configuration for physical uplink shared channel (PUSCH) resources and sequences for modulation and coding schemes (MCSs) and payload sizes. The method may include transmitting a sequence that corresponds to a selected MCS and payload size. The method may include transmitting a PUSCH message using a PUSCH resource and the selected MCS and payload size.

Some aspects described herein relate to a method of wireless communication performed by a network entity. The method may include transmitting a resource pool configuration for PUSCH resources and sequences for MCSs and payload sizes. The method may include receiving a sequence that corresponds to a selected MCS and payload size. The method may include receiving, based at least in part on the sequence, a PUSCH message using the selected MCS and payload size.

Some aspects described herein relate to a UE. The UE may include a processing system. The processing system may include one or more processors and one or more code-storing memories coupled with the one or more processors. The processing system may be configured to cause the UE to receive a resource pool configuration for PUSCH resources and sequences for MCSs and payload sizes. The processing system may be configured to cause the UE to transmit a sequence that corresponds to a selected MCS and payload size. The processing system may be configured to cause the UE to transmit a PUSCH message using a PUSCH resource and the selected MCS and payload size.

Some aspects described herein relate to a network entity. The network entity may include a processing system. The processing system may include one or more processors and one or more code-storing memories coupled with the one or more processors. The processing system may be configured to cause the network entity to transmit a resource pool configuration for PUSCH resources and sequences for MCSs and payload sizes. The processing system may be configured to cause the network entity to receive a sequence that corresponds to a selected MCS and payload size. The processing system may be configured to cause the network entity to receive, based at least in part on the sequence, a PUSCH message using the selected MCS and payload size.

Some aspects described herein relate to a non-transitory computer-readable medium that stores a set of instructions for wireless communication by a UE. The set of instructions, when executed by one or more processors of the UE, may cause the UE to receive a resource pool configuration for PUSCH resources and sequences for MCSs and payload sizes. The set of instructions, when executed by one or more processors of the UE, may cause the UE to transmit a sequence that corresponds to a selected MCS and payload size. The set of instructions, when executed by one or more processors of the UE, may cause the UE to transmit a PUSCH message using a PUSCH resource and the selected MCS and payload size.

Some aspects described herein relate to a non-transitory computer-readable medium that stores a set of instructions for wireless communication by a network entity. The set of instructions, when executed by one or more processors of the network entity, may cause the network entity to transmit a resource pool configuration for PUSCH resources and sequences for MCSs and payload sizes. The set of instructions, when executed by one or more processors of the network entity, may cause the network entity to receive a sequence that corresponds to a selected MCS and payload size. The set of instructions, when executed by one or more processors of the network entity, may cause the network entity to receive, based at least in part on the sequence, a PUSCH message using the selected MCS and payload size.

Some aspects described herein relate to an apparatus for wireless communication. The apparatus may include means for receiving a resource pool configuration for PUSCH resources and sequences for MCSs and payload sizes. The apparatus may include means for transmitting a sequence that corresponds to a selected MCS and payload size. The apparatus may include means for transmitting a PUSCH message using a PUSCH resource and the selected MCS and payload size.

Some aspects described herein relate to an apparatus for wireless communication. The apparatus may include means for transmitting a resource pool configuration for PUSCH resources and sequences for MCSs and payload sizes. The apparatus may include means for receiving a sequence that corresponds to a selected MCS and payload size. The apparatus may include means for receiving, based at least in part on the sequence, a PUSCH message using the selected MCS and payload size.

The systems, methods, and devices of this disclosure each have several innovative aspects, no single one of which is solely responsible for the desirable attributes disclosed herein.

Aspects of the present disclosure may generally be implemented by or as a method, apparatus, system, computer program product, non-transitory computer-readable medium, user equipment, network node, wireless communication device, or processing system as substantially described in the Detailed Description with reference to, and as illustrated by, the accompanying drawings. Details of one or more implementations of the subject matter described in this disclosure are set forth in the accompanying drawings, and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 is a diagram illustrating an example of a wireless communication network.

FIG. 2 is a diagram illustrating an example disaggregated network node architecture.

FIG. 3 is a diagram illustrating an example of configured grant (CG) communication.

FIG. 4 is a diagram illustrating an example of a self-scheduled user equipment (UE), in accordance with the present disclosure.

FIG. 5 is a diagram illustrating an example of sequence design, in accordance with the present disclosure.

FIG. 6 is a diagram illustrating an example process performed, for example, at a UE or an apparatus of a UE.

FIG. 7 is a diagram illustrating an example process performed, for example, at a network entity or an apparatus of a network entity.

FIG. 8 is a diagram of an example apparatus for wireless communication.

FIG. 9 is a diagram of an example apparatus for wireless communication.

### DETAILED DESCRIPTION

A network entity may transmit a configured grant (CG) configuration to a user equipment (UE). For example, the network node may transmit configuration information that identifies the CG. In some aspects, the configuration information identifying the CG may indicate a resource allocation (e.g., in a time domain, frequency domain, spatial domain, or code domain) or a periodicity associated with the resource allocation. The CG may identify a resource or set of resources available to the UE for transmission of an uplink communication (e.g., data or control information). For example, the CG configuration may identify a resource allocation to the UE for a physical uplink shared channel (PUSCH) message.

UE uplink scheduling may be a CG enhancement that reduces signaling overhead. In the case of a self-scheduled UE, the UE will directly select a resource for a given payload size and transmit a message. However, different UEs may collide based on resource usage, cause interference for each other, and degrade performance. When UEs self-schedule their uplink transmissions, the network entity must perform blind decoding to identify the transmitting UEs and their respective MCS and payload sizes. This process can be computationally intensive and may not scale well with an increasing number of UEs.

In some scenarios, a network entity may configure a resource pool instead of a per-UE configuration. For example, the network entity may configure a resource pool and allocate each resource to multiple UEs (no physical random access channel (PRACH) is needed). However, the MCS and payload size may vary with multiple overlapping configurations.

Various aspects relate generally to CG. Some aspects more specifically relate to a network entity configuring a resource pool for PUSCH resources and sequences for MCSs and payload sizes, allowing UEs to self-schedule their uplink transmissions based on the configuration.

Particular aspects of the subject matter described in this disclosure can be implemented to realize one or more of the following potential advantages. By transmitting sequences that indicate the selected MCS and payload size, and using these sequences to inform the network entity of the PUSCH resources being used, the UE may reduce control signaling overhead, improve resource utilization, and simplify the blind decoding process. Additionally, feedback mechanisms may ensure reliable communication and handle retransmissions when necessary.

5G New Radio (NR) may support enhanced mobile broadband (eMBB) access, Internet of Things (IoT) networks or reduced capability (RedCap) device deployments, ultra-reliable low-latency communication (URLLC) applications, or massive machine-type communication (mMTC), among other examples. To support these and other target verticals, a wireless communication system may be designed to implement a modularized functional infrastructure, a disaggregated and service-based network architecture, network function virtualization, network slicing, multi-access edge computing, millimeter wave (mmWave) technologies including massive multiple-input multiple-output (MIMO), beamforming, IoT device or RedCap device connectivity and management, industrial connectivity, licensed and unlicensed spectrum access, sidelink and other device-to-device direct communication (for example, cellular vehicle-to-everything (CV2X) communication), frequency spectrum expansion, overlapping spectrum use, small cell deployments, non-terrestrial network (NTN) deployments, device aggregation, advanced duplex communication (for example, sub-band full-duplex (SBFD)), multiple-subscriber implementations, high-precision positioning, radio frequency (RF) sensing, network energy savings (NES), low-power signaling and radios, or artificial intelligence or machine learning (AI/ML), among other examples.

The foregoing and other technological improvements may support use cases, such as wireless fronthauls, wireless midhauls, wireless backhauls, wireless data centers, extended reality (XR) and metaverse applications, meta services for supporting vehicle connectivity, holographic and mixed reality communication, autonomous and collaborative robots, vehicle platooning and cooperative maneuvering, sensing networks, gesture monitoring, human-brain interfacing, digital twin applications, asset management, and universal coverage applications using non-terrestrial or aerial platforms, among other examples.

The methods, operations, apparatuses, and techniques described herein may enable one or more of the foregoing technologies or new technologies or support one or more of the foregoing use cases or new use cases.

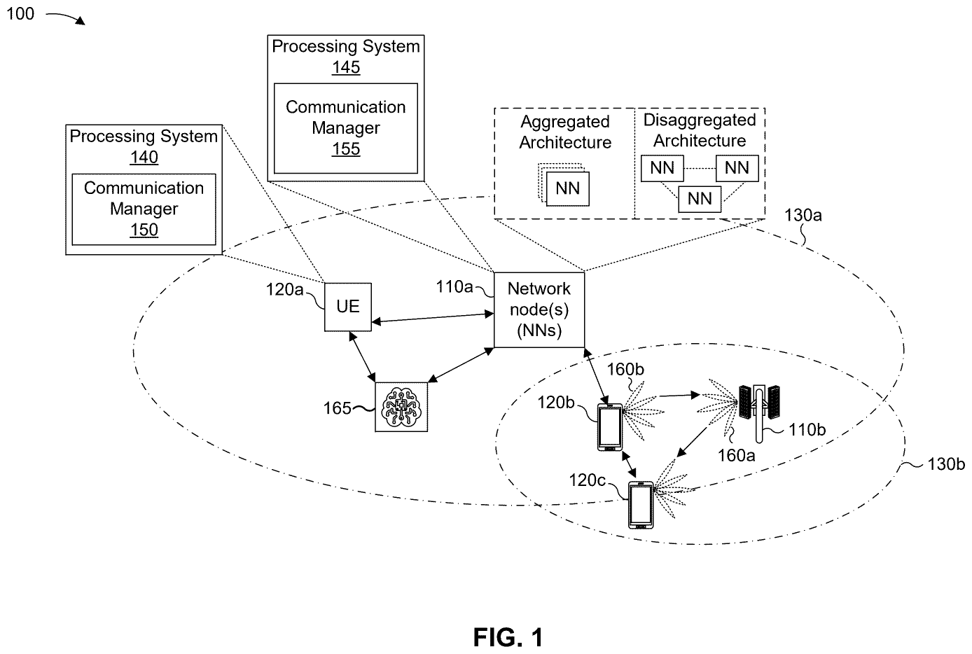

FIG. 1 is a diagram illustrating an example of a wireless communication network 100. The wireless communication network 100 may be or may include elements of a 5G network or a 6G network, among other examples. The wireless communication network 100 may include multiple network nodes 110. For example, in FIG. 1, the wireless communication network 100 includes multiple network nodes 110, including a network node 110a and a network node 110b (each of which also may be referred to herein simply as a “network node 110”). The network nodes 110 may support communications with multiple UEs 120. For example, in FIG. 1, the network nodes 110 support communication with a UE 120a, a UE 120b, and a UE 120c (each of which also may be referred to herein simply as a “UE 120”). In some examples, a UE 120 also may communicate with other UEs 120 and a network node 110 also may communicate with a core network and with other network nodes 110.

The network nodes 110 and the UEs 120 of the wireless communication network 100 communicate using the electromagnetic spectrum, which may be subdivided into various licensed or unlicensed operating bands, frequency ranges, component carriers, or channels that define associated frequencies available for communications. In some examples, each of the network nodes 110 and the UEs 120 may communicate using one or multiple component carriers in one or more operating bands or ranges. Typically, various operating bands are defined as frequency range designations FR1 (410 MHz through 7.125 GHz), FR2 (24.25 GHz through 52.6 GHz), FR3 (7.125 GHz through 24.25 GHz), FR4a or FR4-1 (52.6 GHz through 71 GHz), FR4 (52.6 GHz through 114.25 GHz), and FR5 (114.25 GHz through 300 GHz). Although a portion of FR1 is greater than 6 GHz, FR1 is often referred to (interchangeably) as a “sub-6 GHz” band in some documents and articles. Similarly, FR2 is often referred to (interchangeably) as a “millimeter wave” band in some documents and articles.

A network node 110 or a UE 120 may include one or more devices, components, or systems that enable communication with other devices, components, or systems of the wireless communication network 100. For example, a UE 120 and a network node 110 may each include one or more chips, system-on-chips (SoCs), chipsets, packages, or devices that individually or collectively constitute or comprise a processing system. As shown in FIG. 1, each UE 120 includes a processing system 140 and each network node 110 includes a processing system 145. A processing system (for example, the processing system 140 or the processing system 145) includes processor (or “processing”) circuitry in the form of one or multiple processors, microprocessors, processing units (such as central processing units (CPUs), graphics processing units (GPUs), neural processing units (NPUs) (also referred to as neural network processors or deep learning processors (DLPs)), or digital signal processors (DSPs)), processing blocks, application-specific integrated circuits (ASICs), programmable logic devices (PLDs), or other discrete gate or transistor logic or circuitry (any one or more of which may be generally referred to herein individually as a “processor” or collectively as “the processor” or “the processor circuitry”). Such processors may be individually or collectively configurable or configured to perform various functions or operations described herein. A group of processors collectively configurable or configured to perform a set of functions may include a first processor configurable or configured to perform a first function of the set and a second processor configurable or configured to perform a second function of the set. In some other examples, each of a group of processors may be configurable or configured to perform a same set of functions.

The processing system 140 and the processing system 145 may each include memory circuitry in the form of one or multiple memory devices, memory blocks, memory elements, or other discrete gate or transistor logic or circuitry, each of which may include or implement tangible storage media, such as random-access memory, or read-only memory, or combinations thereof (any one or more of which may be generally referred to herein individually as a “memory” or collectively as “the memory” or “the memory circuitry”). One or more of the memories may be coupled (for example, operatively coupled, communicatively coupled, electronically coupled, or electrically coupled) with one or more of the processors. One or more of the memories may individually or collectively store processor-executable code or instructions (such as software) (for example, which may referred to as “one or more code-storing memories” or “code-storing memory circuitry”). For example, “code-storing memory” or “code-storing memory circuitry” refers to memory (or memory circuitry) that is configured to store processor-executable code or instructions. The processor-executable code or instructions, when executed by one or more of the processors, may configure one or more of the processors (or processing circuitry) to perform various functions or operations described herein. Additionally, or alternatively, in some examples, one or more of the processors may be configured to perform various functions or operations described herein without requiring configuration by software. Software shall be construed broadly to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise.

The processing system 140 and the processing system 145 may each include or be coupled with one or more modems (such as a cellular (for example, a 5G or 6G compliant) modem). In some examples, one or more processors of the processing system 140 or the processing system 145 may include or implement one or more of the modems. The processing system 140 and the processing system 145 also may include or be coupled with multiple radios (collectively “the radio”), multiple RF chains, or multiple transceivers, each of which may in turn be coupled with one or more of multiple antennas. In some examples, one or more processors of the processing system 140 or the processing system 145 may include or implement one or more of the radios, RF chains, or transceivers. An RF chain may include one or more filters, mixers, oscillators, amplifiers, analog-to-digital converters (ADCs), or other devices that convert between an analog signal (such as for transmission or reception via an air interface) and a digital signal (such as for processing by the processing system 140 or by the processing system 145).

A network node 110 and a UE 120 may each include one or multiple antennas or antenna arrays. Typical network nodes 110 and UEs 120 may include multiple antennas, which may be organized or structured into one or more antenna panels, one or more antenna groups, one or more sets of antenna elements, or one or more antenna arrays, among other examples. As used herein, the term “antenna” can refer to one or more antennas, one or more antenna panels, one or more antenna groups, one or more sets of antenna elements, or one or more antenna arrays. The term “antenna panel” can refer to a group of antennas (such as antenna elements) arranged in an array or panel, which may facilitate beamforming by manipulating parameters associated with the group of antennas. The term “antenna module” may refer to circuitry including one or more antennas as well as one or more other components (such as filters, amplifiers, or processors) associated with integrating the antenna module into a wireless communication device, such as the network node 110 and the UE 120.

A network node 110 may be, may include, or also may be referred to as an NR network node, a 5G network node, a 6G network node, a Node B, a gNB, an access point (AP), a transmission reception point (TRP), a network entity, a network element, a network equipment, or another type of device, component, or system included in a radio access network (RAN). In various deployments, a network node 110 may be implemented as a single physical node (for example, a single physical structure) or may be implemented as two or more physical nodes (for example, two or more distinct physical structures). For example, a network node 110 may be a device or system that implements a part of a radio protocol stack, a device or system that implements a full radio protocol stack (such as a full gNB protocol stack), or a collection of devices or systems that collectively implement the full radio protocol stack. For example, and as shown, a network node 110 may be an aggregated network node having an aggregated architecture, meaning that the network node 110 may implement a full radio protocol stack that is physically and logically integrated within a single physical structure in the wireless communication network 100. For example, an aggregated network node 110 may include a single standalone base station or a single TRP that operates with a full radio protocol stack to enable or facilitate communication between a UE 120 and a core network of the wireless communication network 100.

Alternatively, and as also shown, a network node 110 may be a disaggregated network node 110 (sometimes referred to as a disaggregated base station), having a disaggregated architecture, meaning that the network node 110 may operate with a radio protocol stack that is physically distributed or logically distributed among two or more nodes in the same geographic location or in different geographic locations. In some deployments, disaggregated network nodes 110 may be used in an integrated access and backhaul (IAB) network, in an open radio access network (O-RAN) (such as a network configuration in compliance with the O-RAN Alliance), or in a virtualized radio access network (vRAN), also known as a cloud radio access network (C-RAN), to facilitate scaling by separating network functionality into multiple units or modules that can be individually deployed.

The disaggregated network nodes 110 of the wireless communication network 100 may include one or more central units (CUs), one or more distributed units (DUs), and one or more radio units (RUs). A CU may host one or more higher layers, such as a radio resource control (RRC) layer, a packet data convergence protocol (PDCP) layer, and a service data adaptation protocol (SDAP) layer, among other examples. A DU may host one or more of a radio link control (RLC) layer, a medium access control (MAC) layer, or one or more higher physical (PHY) layers depending, at least in part, on a functional split, such as a functional split defined by the 3GPP. In some examples, a DU also may host a lower PHY layer that is configured to perform functions, such as a fast Fourier transform (FFT), an inverse FFT (IFFT), beamforming, or physical random access channel (PRACH) extraction and filtering, among other examples. An RU may perform RF processing functions or lower PHY layer functions, such as an FFT, an IFFT, beamforming, or PRACH extraction and filtering, among other examples, according to a functional split, such as a lower layer split (LLS). In such an architecture, each RU can be operated to handle over the air (OTA) communication with one or more UEs 120. In some examples, a single network node 110 may include a combination of one or more CUs, one or more DUs, or one or more RUs. In some examples, a CU, a DU, or an RU may be implemented as a virtual unit, such as a virtual central unit (VCU), a virtual distributed unit (VDU), or a virtual radio unit (VRU), among other examples, which may be implemented as a virtual network function, such as in a cloud deployment.

In some examples, the wireless communication network 100 may be a heterogeneous network that includes network nodes 110 of various types. Different types of network nodes 110 may generally operate on the same or different operating bands, transmit at different power levels, or serve different coverage areas, each of which may be referred to as or associated with a particular cell 130 (for example, a cell 130a and a cell 130b).

The UEs 120 may be physically dispersed throughout the coverage area of the wireless communication network 100, and each UE 120 may be stationary or mobile. A

UE 120 may be, may include, or also may be referred to as an access terminal, a mobile station, a client device, or a subscriber unit. A UE 120 may be, include, or be coupled with a cellular phone (for example, a smart phone), a personal digital assistant (PDA), a wireless modem, a wireless communication device, a handheld device, a laptop computer, a cordless phone, a wireless local loop (WLL) station, a tablet, a camera, a netbook, a smartbook, an ultrabook, a medical device, a biometric device, a wearable device (for example, a smart watch, smart clothing, smart glasses, a smart wristband, or smart jewelry), a gaming device, an entertainment device (for example, a music device, a video device, or a satellite radio), an XR device, a vehicular component or sensor, a smart meter or sensor, industrial manufacturing equipment, a Global Navigation Satellite System (GNSS) device (such as a Global Positioning System device or another type of positioning device), an artificially intelligent robot or other device implementing artificial intelligence, a UE function of a network node, or any other suitable device or function that may communicate in the wireless communication network 100.

Some UEs 120 may be classified according to different categories in association with different complexities or different capabilities. UEs 120 in a first category may be associated with relatively low complexity or cost such as NB-IoT devices or eMTC UEs. UEs 120 in a second category may include higher complexity or cost devices, such as mission-critical IoT devices, baseline UEs, high-tier UEs, advanced UEs, full-capability UEs, or premium UEs that are capable of URLLC, eMBB, or precise positioning in the wireless communication network 100. A third category of UEs 120 may have mid-tier complexity or capabilities (for example, capabilities between that of the UEs 120 of the first category and the UEs 120 of the second category). A UE 120 of the third category may be referred to as a reduced capability UE (“RedCap UE”), a mid-tier UE, an NR-Light UE, or an NR-Lite UE, among other examples.

In some examples, a network node 110 may be, may include, or may operate as an RU, a TRP, or a base station that communicates with one or more UEs 120 via a radio access link (which may be referred to as a “Uu” link). The radio access link may include a downlink and an uplink. “Downlink” (or “DL”) refers to a communication direction from a network node 110 to a UE 120, and “uplink” (or “UL”) refers to a communication direction from a UE 120 to a network node 110. Downlink and uplink resources may include time domain resources (for example, frames, subframes, slots, and symbols), frequency domain resources (for example, frequency bands, component carriers (CCs), subcarriers, resource blocks, and resource elements), and spatial domain resources (for example, particular transmit directions or beams).

Frequency domain resources may be subdivided into bandwidth parts (BWPs). A BWP may be a block of frequency domain resources (for example, a continuous set of resource blocks (RBs) within a full component carrier bandwidth) that may be configured at a UE-specific level. A UE 120 may be configured with both an uplink BWP and a downlink BWP (which may be the same or different). Each BWP may be associated with its own numerology (indicating a sub-carrier spacing (SCS) and cyclic prefix (CP)). A BWP may be dynamically configured or activated (for example, by a network node 110 transmitting a downlink control information (DCI) configuration to the one or more UEs 120) or reconfigured (for example, in real-time or near-real-time) according to changing network conditions in the wireless communication network 100 or specific requirements of one or more UEs 120. An active BWP defines the operating bandwidth of the UE 120 within the operating bandwidth of the serving cell.

As used herein, a downlink signal may be or include a reference signal, control information, or data. For example, downlink reference signals include a primary synchronization signal (PSS), a secondary SS (SSS), an SS block (SSB) (for example, that includes a PSS, an SSS, and a physical broadcast channel (PBCH)), a demodulation reference signal (DMRS), a phase tracking reference signal (PTRS), a tracking reference signal (TRS), and a channel state information (CSI) reference signal (CSI-RS), among other examples. A downlink signal carrying control information or data may be transmitted via a downlink channel. Downlink channels may include one or more control channels for transmitting control information and one or more data channels for transmitting data. Downlink reference signals may be transmitted in addition to, or multiplexed with, downlink control channel communications or downlink data channel communications. A downlink control channel may be specifically used to transmit DCI from a network node 110 to a UE 120. DCI generally contains the information the UE 120 needs to identify RBs in a subsequent subframe and how to decode them, including a modulation and coding scheme (MCS) or redundancy version parameters. Different DCI formats carry different information, such as scheduling information in the form of downlink or uplink grants, slot format indicators (SFIs), preemption indicators (PIs), transmit power control (TPC) commands, hybrid automatic repeat request (HARQ) information, new data indicators (NDIs), among other examples. A downlink data channel may be used to transmit downlink data (for example, user data associated with a UE 120) from a network node 110 to a UE 120. Downlink control channels may include physical downlink control channels (PDCCHs), and downlink data channels may include physical downlink shared channels (PDSCHs). Control information or data communications may be transmitted on a PDCCH and PDSCH, respectively. For example, a PDCCH can carry DCI, while a PDSCH can carry a MAC control element (MAC-CE), an RRC message, or user data, among other examples. Each PDSCH may carry one or more transport blocks (TBs) of data.

As used herein, an uplink signal may include a reference signal, control information, or data. For example, uplink reference signals include a sounding reference signal (SRS), a PTRS, and a DMRS, among other examples. An uplink signal carrying control information or data may be transmitted via an uplink channel. An uplink channel may include one or more control channels for transmitting control information and one or more data channels for transmitting data. Uplink reference signals may be transmitted in addition to, or multiplexed with, uplink control channel communications or uplink data channel communications. An uplink control channel may be specifically used to transmit UCI from a UE 120 to a network node 110. An uplink data channel may be used to transmit uplink data (for example, user data associated with a UE 120) from a UE 120 to a network node 110. Uplink control channels may include physical uplink control channels (PUCCHs), and uplink data channels may include physical uplink shared channels (PUSCHs). Control information or data communications may be transmitted on a PUCCH and PUSCH, respectively. For example, a PUCCH can carry UCI, while a PUSCH can carry a MAC-CE, an RRC message, or user data, among other examples. UCI can include a scheduling request (SR), HARQ feedback information (for example, a HARQ acknowledgement (ACK) indication or a HARQ negative acknowledgement (NACK) indication), uplink power control information (for example, an uplink TPC parameter), or CSI, among other examples. CSI can include a channel quality indicator (CQI) (indicative of downlink channel conditions to facilitate selection of transmission parameters, such as an MCS, by a network node 110), a precoding matrix indicator (PMI), a CSI-RS resource indicator (CRI) (for example, indicative of a beam used to transmit a CSI-RS), an SS/PBCH resource block indicator (SSBRI) (for example, indicative of a beam used to transmit an SSB), a layer indicator (LI), a rank indicator (RI), or measurement information (for example, a layer 1 (L1)-reference signal received power (RSRP) parameter, a received signal strength indicator (RSSI) parameter, a reference signal received quality (RSRQ) parameter, among other examples) which can be used for beam management, among other examples. Each PUSCH may carry one or more TBs of data.

The information (for example, data, control information, or reference signal information) transmitted by a network node 110 to a UE 120, or vice versa, may be represented as a sequence of binary bits that are mapped (for example, modulated) to an analog signal waveform (for example, a discrete Fourier transform (DFT)-spread-orthogonal frequency division multiplexing (OFDM) (DFT-s-OFDM) waveform or a CP-OFDM waveform) that is transmitted by the network node 110 or UE 120 over a wireless communication channel. In some examples, the network node 110 or the UE 120 (for example, using the processing system 145 or the processing system 140, respectively) may select an MCS (for example, an order of quadrature amplitude modulation (QAM), such as 64-QAM, 128-QAM, or 256-QAM, among other examples) for a downlink signal or an uplink signal. For example, the network node 110 may select an MCS for a downlink signal in accordance with UCI received from the UE 120 or may transmit, to the UE 120, an indication of an MCS to be applied for an uplink signal.

A network node 110 or a UE 120 (such as by using the processing system 145 or the processing system 140, respectively, or one or more coupled modems) may perform signal processing on the information (such as filtering, amplification, modulation, digital-to-analog conversion, an IFFT operation, multiplexing, interleaving, mapping, or encoding, among other examples) to generate a processed signal in accordance with the selected MCS. In some examples, the network node 110 or the UE 120 (for example, using the processing system 145 or the processing system 140, respectively, or one or more coupled encoders or modems) may perform a channel coding operation or a forward error correction (FEC) operation to control errors in transmitted information. For example, the network node 110 or the UE 120 may perform an encoding operation to generate encoded information (such as by selectively introducing redundancy into the information, typically using an error correction code (ECC), such as a polar code or a low-density parity-check (LDPC) code). The network node 110 or the UE 120 (for example, using the processing system 145 or one or more modems) may further perform spatial processing (for example, precoding) on the encoded information to generate one or more processed or precoded signals for downlink or uplink transmission, respectively. In some examples, the network node 110a or the UE 120a may perform codebook-based precoding or non-codebook-based precoding. Codebook-based precoding may involve selecting a precoder (for example, a precoding matrix) using a codebook. For example, the network node 110a may provide precoding information indicating which precoder, defined by the codebook, is to be used by the UE 120a. Non-codebook-based precoding may involve selecting or deriving a precoder based on, or otherwise associated with, one or more downlink or uplink signal measurements. The network node 110a or the UE 120a may transmit the processed downlink or uplink signals, respectively, via one or more antennas.

The network node 110a or the UE 120a may receive uplink signals or downlink signals, respectively, via one or more antennas. The network node 110a or the UE 120a (for example, using the processing system 145 or the processing system 140, respectively, or one or more coupled modems) may perform signal processing (for example, in accordance with the MCS) on the received uplink or downlink signals, respectively (such as filtering, amplification, demodulation, analog-to-digital conversion, an FFT operation, demultiplexing, deinterleaving, de-mapping, equalization, interference cancellation, or decoding, among other examples), to map the received signal(s) to a sequence of binary bits (for example, received information) that estimates the information transmitted by the network node 110 or the UE 120 via the downlink or uplink signals. The network node 110a or the UE 120a (for example, using the processing system 145 or the processing system 140, respectively, or a coupled decoder or one or more modems) may decode the received information (such as by using an ECC, a decoding operation, or an FEC operation) to detect errors or correct bit errors in the received information to generate decoded information. The decoded information may estimate the information transmitted via the downlink or uplink signals.

In some examples, a UE 120 and a network node 110 may perform MIMO communication. MIMO communication generally refers to transmitting or receiving multiple signals (such as multiple layers or multiple data streams) simultaneously over the same time and frequency resources. A network node 110 or a UE 120 may communicate using single-user MIMO or multi-user MIMO (MU-MIMO), the latter of which being used by a network node 110 to simultaneously transmit signals to multiple UEs 120. MIMO techniques may involve spatial multiplexing (multi-layer transmission) or beamforming. To implement beamforming, the amplitudes or phases of signals transmitted via antenna elements may be modulated and shifted relative to each other (such as by manipulating a phase shift, a phase offset, or an amplitude) to generate one or more beams. For example, a network node 110 may generate one or more beams 160a, and a UE 120 may generate one or more beams 160b. The term “beam” may refer to a directional transmission of a wireless signal toward a receiving device or otherwise in a desired direction, a directional reception of a wireless signal from a transmitting device or otherwise in a desired direction, a direction associated with such a directional transmission or directional reception, a set of directional resources associated with a signal transmission or signal reception (for example, an angle of arrival, a horizontal direction, or a vertical direction), or a set of parameters or resources associated with one or more aspects of a directional signal, among other examples.

In some examples, a network node 110 or a UE 120 may implement massive MIMO, which may be associated with an increased (for example, “massive”) quantity of antennas at the network node 110 or at the UE 120, such as in a network implementing mmWave technology, which enables more precise beamforming or reduced interference. In some examples, the wireless communication network 100 may implement multi-TRP (mTRP) operation (including redundant transmission or reception on multiple TRPs) or non-coherent joint transmission (NC-JT).

The network node 110 and the UE 120 may establish a communication link or beam pair, and otherwise increase reliability, throughput, signal strength, or other signal properties for MIMO communications, by performing beam management operations, such as an initial beam acquisition operation, a beam refinement operation, or a beam recovery operation. For example, an initial beam acquisition operation may involve the network node 110 transmitting signals (for example, SSBs or other signals) via respective beams (for example, of the beams 160 of the network node 110) and the UE 120 receiving and measuring the signal(s) via respective beams of multiple beams (for example, from the beams 160 of the UE 120) to identify a best beam (or beam pair) for communication between the UE 120 and the network node 110. A beam refinement operation may involve a first device (for example, the UE 120 or the network node 110) transmitting signal(s) via a subset of beams (for example, identified based on, or otherwise associated with, measurements reported as part of one or more other beam management operations). A second device (for example, the network node 110 or the UE 120) may receive the signal(s) via a single beam (for example, to identify the best beam for communication from the subset of beams). The beam(s) may be identified or defined via one or more spatial parameters, such as a transmission configuration indicator (TCI) state or a quasi co-location (QCL) parameter, among other examples.

Some aspects and techniques as described herein may be implemented, at least in part, using an artificial intelligence (AI) program (for example, referred to herein as an “AI/ML model”), such as a program that includes a machine learning (ML) model or an artificial neural network (ANN) model. The AI/ML model may be deployed at one or more devices 165 (for example, one or more network nodes 110, one or more UEs 120, one or more servers, or one or more components of a cloud computing network, among other examples). For example, in a deployment in which AI/ML functionality is performed independently at a device 165, sometimes referred to as “overlay AI/ML,” the AI/ML model (or an instance or portion of the AI/ML model) may be deployed at a UE 120 (for example, by the processing system 140), a network node 110 (for example, by the processing system 145), one or more servers, or one or more components of a cloud computing network, among other examples. Additionally, or alternatively, in a deployment where AI/ML functionality is coordinated between different devices 165, sometimes referred to as “coordinated AI/ML,” or performed at all device and network layers, sometimes referred to as “native AI/ML,” the AI/ML model (or an instance of the AI/ML model) may be deployed at multiple devices 165 (for example, a first portion of the AI/ML model may be deployed at a UE 120 and a second portion of the AI/ML model may be deployed at a network node 110). In other examples of coordinated AI/ML or native AI/ML, a first AI/ML model may be deployed at a UE 120 and a second AI/ML model may be deployed at a network node 110. The AI/ML model(s) may be configured to enhance various aspects of the wireless communication network 100 (for example, to increase privacy, reliability, or efficient use of network bandwidth, or to reduce latency, among other examples). For example, the AI/ML model(s) may be trained to identify patterns or relationships in data corresponding to the wireless communication network 100, a device, or an air interface, among other examples. The AI/ML model(s) may support operational decisions relating to one or more aspects associated with wireless communications devices, networks, or services.

Accordingly, in some examples, the AI/ML model(s) may enable AI-as-a-Service (for example, an end-to-end AI/ML service via a user plane) for use cases, such as a self-organizing network (SON), minimization of drive test (MDT), quality of experience (QoE), positioning, sensing, predictive mobility, or traffic prediction, among other examples. In some examples, AI-as-a-Service use cases may include measurement collection reporting by a UE 120, device selection criteria (for example, according to a geographical area where measurements are to be collected or UE capabilities to be used to collected measurements), or reporting configurations (for example, reporting parameters such as location, time, or sensor information, among other examples). Additionally, or alternatively, the AI/ML model(s) may enable AI/ML procedures (for example, RAN-triggered service establishment, configuration, inferencing using UE-side or network-side models, performance monitoring or management, or capability signaling, among other examples). Additionally, or alternatively, the AI/ML model(s) may enable RAN-based AI/ML services via one or more application program interfaces (APIs) or management interfaces for use cases, such as beam management, radio resource monitoring (RRM) relaxation, mobility prediction, load prediction, network energy savings, or coverage and capacity improvements, among other examples).

In some aspects, a UE (e.g., a UE 120) may include a communication manager 150. As described in more detail elsewhere herein, the communication manager 150 may receive a resource pool configuration for PUSCH resources and sequences for MCSs and payload sizes; transmit a sequence that corresponds to a selected MCS and payload size; and transmit a PUSCH message using a PUSCH resource and the selected MCS and payload size. Additionally, or alternatively, the communication manager 150 may perform one or more other operations described herein.

In some aspects, a network entity (e.g., a network node 110) may include a communication manager 155. As described in more detail elsewhere herein, the communication manager 155 may transmit a resource pool configuration for PUSCH resources and sequences for MCSs and payload sizes; receive a sequence that corresponds to a selected MCS and payload size; and receive, based at least in part on the sequence, a PUSCH message using the selected MCS and payload size. Additionally, or alternatively, the communication manager 155 may perform one or more other operations described herein.

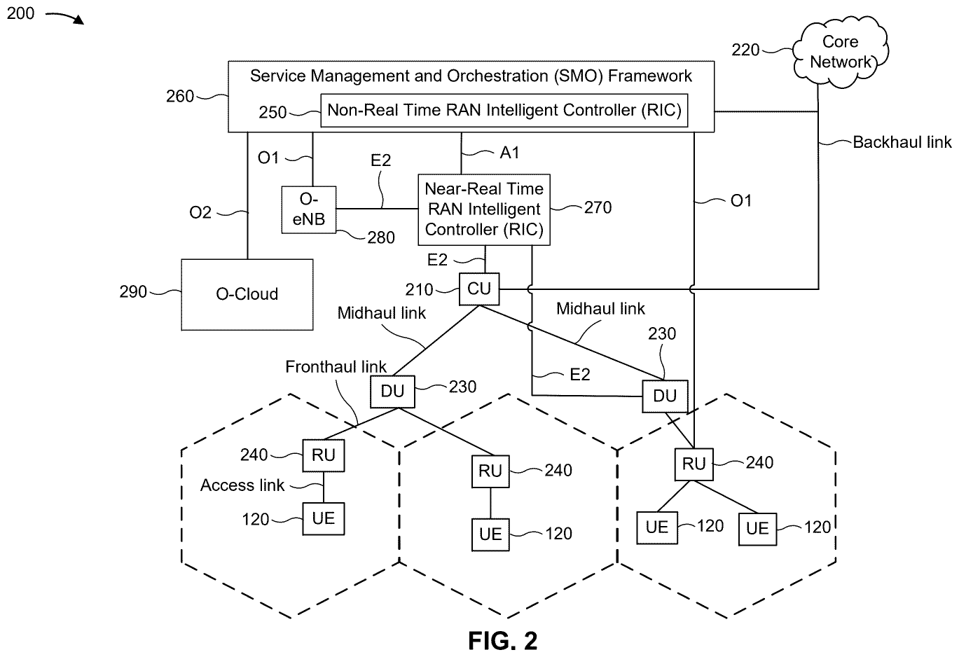

FIG. 2 is a diagram illustrating an example disaggregated network node architecture 200. One or more components of the example disaggregated network node architecture 200 may be, may include, or may be included in one or more network nodes (such one or more network nodes 110). The disaggregated network node architecture 200 may include a CU 210 that can communicate directly with a core network 220 via a backhaul link, or that can communicate indirectly with the core network 220 via one or more disaggregated control units, such as a non-real-time (Non-RT) RAN intelligent controller (RIC) 250 associated with a Service Management and Orchestration (SMO) Framework 260 or a near-real-time (Near-RT) RIC 270 (for example, via an E2 link). The CU 210 may communicate with one or more DUs 230 via respective midhaul links, such as via F1 interfaces. Each of the DUs 230 may communicate with one or more RUs 240 via respective fronthaul links. Each of the RUs 240 may communicate with one or more UEs 120 via respective RF access links. In some deployments, a UE 120 may be simultaneously served by multiple RUs 240.

Each of the components of the disaggregated network node architecture 200, including the CUs 210, the DUs 230, the RUs 240, the Near-RT RICs 270, the Non-RT RICs 250, and the SMO Framework 260, may include one or more interfaces or may be coupled with one or more interfaces for transmitting or receiving signals, such as data, control information, or reference signals via a wired or wireless transmission medium.

In some aspects, the CU 210 may be logically split into one or more CU user plane (CU-UP) units and one or more CU control plane (CU-CP) units. A CU-UP unit may communicate bidirectionally with a CU-CP unit via an interface, such as the E1 interface when implemented in an O-RAN configuration. The CU 210 may be deployed to communicate with one or more DUs 230, as necessary, for network control and signaling. Each DU 230 may correspond to a logical unit that includes one or more base station functions to control the operation of one or more RUs 240. For example, a DU 230 may host various layers, such as an RLC layer, a MAC layer, or one or more PHY layers, such as one or more high PHY layers or one or more low PHY layers. Each layer (which also may be referred to as a module) may be implemented with an interface for communicating signals with other layers (and modules) hosted by the DU 230, or for communicating signals with the control functions hosted by the CU 210. Each RU 240 may implement lower layer functionality. In some aspects, real-time and non-real-time aspects of control and user plane communication with the RU(s) 240 may be controlled by the corresponding DU 230.

The SMO Framework 260 may support RAN deployment and provisioning of non-virtualized and virtualized network elements. For non-virtualized network elements, the SMO Framework 260 may support the deployment of dedicated physical resources for RAN coverage requirements, which may be managed via an operations and maintenance interface, such as an O1 interface. For virtualized network elements, the SMO Framework 260 may interact with a cloud computing platform (such as an open cloud (O-Cloud) platform 290) to perform network element life cycle management (such as to instantiate virtualized network elements) via a cloud computing platform interface, such as an O2 interface. A virtualized network element may include, but is not limited to, a CU 210, a DU 230, an RU 240, a non-RT RIC 250, or a Near-RT RIC 270. In some aspects, the SMO Framework 260 may communicate with a hardware aspect of a 4G RAN, a 5G NR RAN, or a 6G RAN, such as an open eNB (O-eNB) 280, via an O1 interface. Additionally, or alternatively, the SMO Framework 260 may communicate directly with each of one or more RUs 240 via a respective O1 interface. In some deployments, this configuration can enable each DU 230 and the CU 210 to be implemented in a cloud-based RAN architecture, such as a vRAN architecture.

The Non-RT RIC 250 may include or may implement a logical function that enables non-real-time control and optimization of RAN elements and resources, AI/ML workflows including model training and updates, or policy-based guidance of applications or features in the Near-RT RIC 270. The Non-RT RIC 250 may be coupled to or may communicate with (such as via an A1 interface) the Near-RT RIC 270. The Near-RT RIC 270 may include or may implement a logical function that enables near-real-time control and optimization of RAN elements and resources via data collection and actions via an interface (such as via an E2 interface) connecting one or more CUs 210, one or more DUs 230, or an O-eNB 280 with the Near-RT RIC 270.

In some aspects, to generate AI/ML models to be deployed in the Near-RT RIC 270, the Non-RT RIC 250 may receive parameters or external enrichment information from external servers. Such information may be utilized by the Near-RT RIC 270 and may be received at the SMO Framework 260 or the Non-RT RIC 250 from non-network data sources or from network functions. In some examples, the Non-RT RIC 250 or the Near-RT RIC 270 may tune RAN behavior or performance. For example, the Non-RT RIC 250 may monitor long-term trends and patterns for performance and may employ AI/ML models to perform corrective actions via the SMO Framework 260 (such as reconfiguration via an O1 interface) or via creation of RAN management policies (such as A1 interface policies).

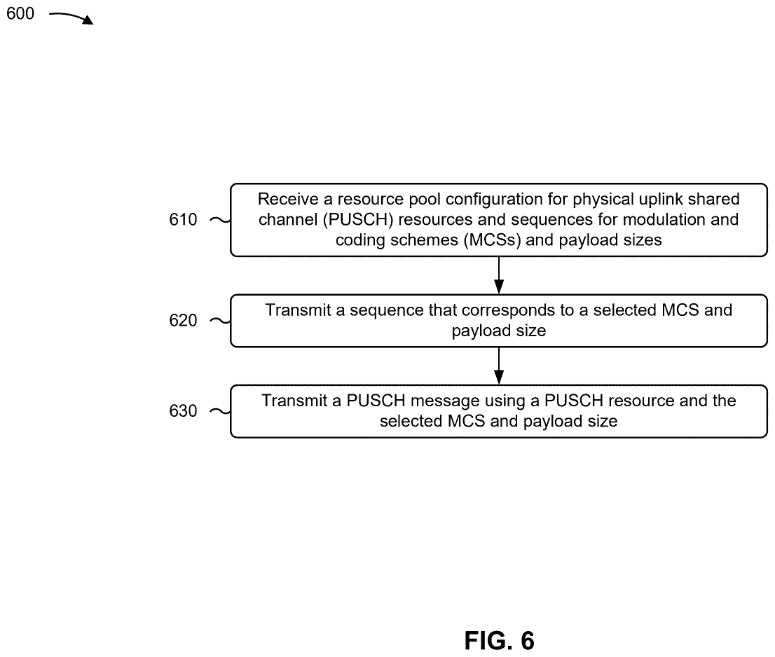

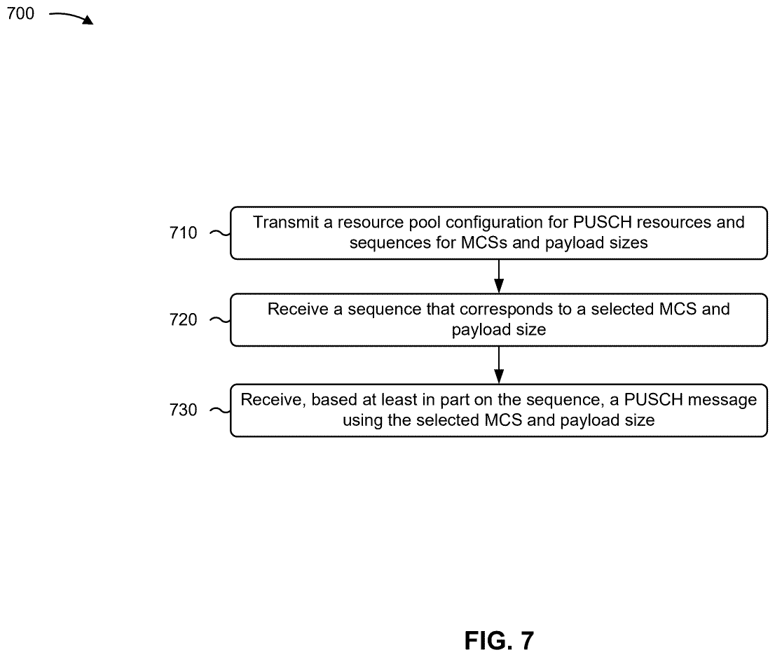

The network node 110, the processing system 145 of the network node 110, the UE 120, the processing system 140 of the UE 120, the CU 210, the DU 230, the RU 240, or any other component(s) of FIG. 1 or FIG. 2 may implement one or more techniques or perform one or more operations associated with a sequence-based indicator for uplink transmission, as described in more detail elsewhere herein. For example, the processing system 145 of the network node 110, the processing system 140 of the UE 120, the CU 210, the DU 230, or the RU 240 may perform or direct operations of, for example, process 600 of FIG. 6, process 700 of FIG. 7, or other processes as described herein (alone or in conjunction with one or more other processors). Memory of the network node 110 may store data and program code (or instructions) for the network node 110, the CU 210, the DU 230, or the RU 240. In some examples, the memory of the network node 110 may store data relating to a UE 120, such as RRC state information or a UE context. Memory of a UE 120 may store data and program code (or instructions) for the UE 120, such as context information. In some examples, the memory of the UE 120 or the memory of the network node 110 may include a non-transitory computer-readable medium storing a set of instructions for wireless communication. For example, the set of instructions, when executed by one or more processors (for example, of the processing system 145 or the processing system 140) of the network node 110, the UE 120, the CU 210, the DU 230, or the RU 240, may cause the one or more processors to perform process 600 of FIG. 6, process 700 of FIG. 7, or other processes as described herein. In some examples, executing instructions may include running the instructions, converting the instructions, compiling the instructions, or interpreting the instructions, among other examples.

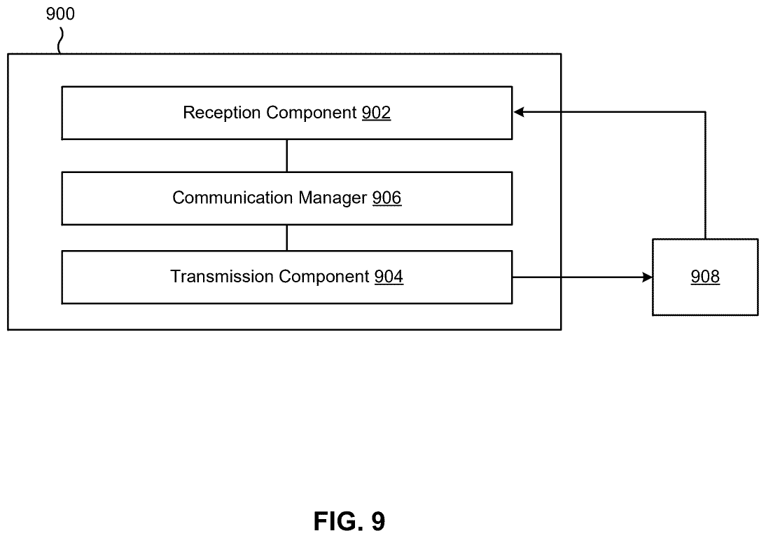

In some aspects, a UE (e.g., a UE 120) includes means for receiving a resource pool configuration for PUSCH resources and sequences for modulation and coding schemes (MCSs) and payload sizes; means for transmitting a sequence that corresponds to a selected MCS and payload size; or means for transmitting a PUSCH message using a PUSCH resource and the selected MCS and payload size. The means for the UE to perform operations described herein may include, for example, one or more of communication manager 150, processing system 140, a radio, one or more RF chains, one or more transceivers, one or more antennas, one or more modems, a reception component (for example, reception component 902 depicted and described in connection with FIG. 9), or a transmission component (for example, transmission component 904 depicted and described in connection with FIG. 9), among other examples.

In some aspects, a network entity (e.g., a network node 110) includes means for transmitting a resource pool configuration for PUSCH resources and sequences for MCSs and payload sizes; means for receiving a sequence that corresponds to a selected MCS and payload size; or means for receiving, based at least in part on the sequence, a PUSCH message using the selected MCS and payload size. In some aspects, the means for the network entity to perform operations described herein may include, for example, one or more of communication manager 155, processing system 145, a radio, one or more RF chains, one or more transceivers, one or more antennas, one or more modems, a reception component (for example, reception component 902 depicted and described in connection with FIG. 9), or a transmission component (for example, transmission component 904 depicted and described in connection with FIG. 9), among other examples.

Usage scenarios for devices may include integrated sensing and communication, immersive communication, AI and communication, massive communication, ubiquitous connectivity, and hyper-reliable low-latency communication. Devices and systems for such scenarios are to be designed for different capabilities, including for low user plane latency, low control plane latency, and high connection density.

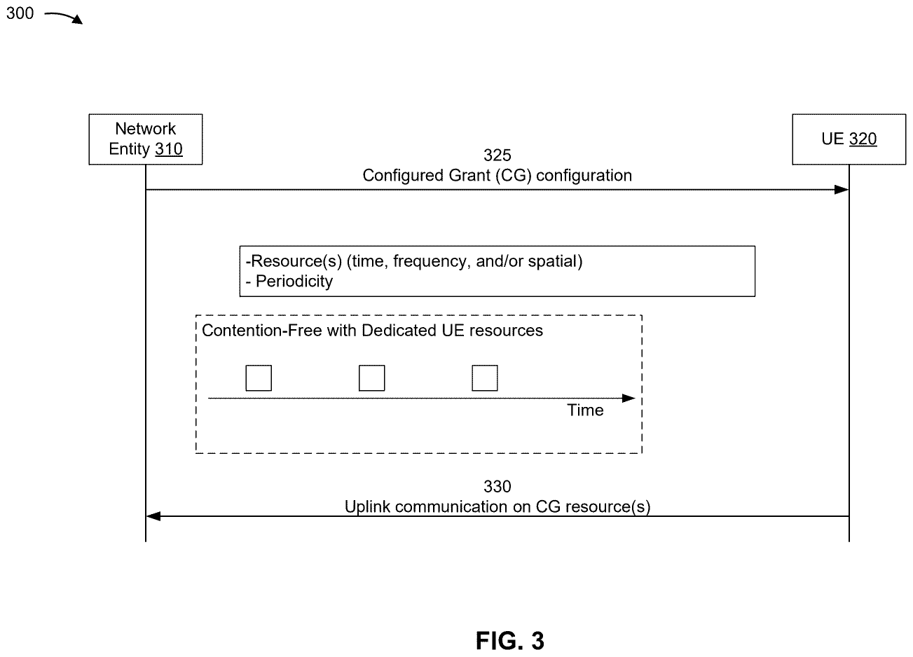

FIG. 3 is a diagram illustrating an example 300 of configured grant (CG) communication. As shown, example 300 includes a network entity 310 and a UE 320.

As shown in FIG. 3, and by reference number 325, the network entity may transmit a CG configuration to the UE. For example, the network entity 310 may transmit configuration information (e.g., in a radio resource configuration (RRC) message, in a downlink control information message, or in another signaling message) that identifies the CG. In some aspects, the configuration information identifying the CG may indicate a resource allocation (e.g., in a time domain, frequency domain, spatial domain, or code domain) or a periodicity associated with the resource allocation. The CG may identify a resource or set of resources available to the UE for transmission of an uplink communication (e.g., data or control information). For example, the CG configuration may identify a resource allocation for a PUSCH.

In some aspects, the CG configuration may configure contention-free CG communication with resources dedicated for the UE to transmit uplink communications. In this case, the CG configuration may indicate a resource allocation (e.g., in a time domain, frequency domain, spatial domain, or code domain) dedicated for the UE to use to transmit uplink communications. In some aspects, the CG configuration may configure the resource allocation for the UE to occur periodically, such that the resource allocation corresponds to periodically occurring transmission time occasions. As shown in FIG. 3, and by reference number 330, when the UE has uplink data to transmit, the UE transmits the uplink data in the CG resources identified by the CG configuration. For example, the UE transmits the uplink data in one of the CG uplink occasions identified in the CG configuration using the configured resource allocation.

UE uplink scheduling may involve a network entity transmitting a large amount of control signaling, including for a high number of UEs (e.g., IoT devices). If a UE self-schedules uplink transmissions, the network entity may reduce signaling overhead. UE self-scheduling may be considered a CG enhancement, given that the network entity will not allow full flexibility for the UE to schedule itself and will provide a configuration and a pool of resources.

In the case of a self-scheduled UE, the UE will directly select a resource for a given payload size and transmit a message. However, different UEs may collide based on resource usage, cause interference for each other, and degrade performance. When UEs self-schedule their uplink transmissions, the network entity must perform blind decoding to identify the transmitting UEs and their respective MCS and payload sizes. This process can be computationally intensive and may not scale well with an increasing number of UEs.

As indicated above, FIG. 3 is provided as an example. Other examples may differ from what is described with respect to FIG. 3.

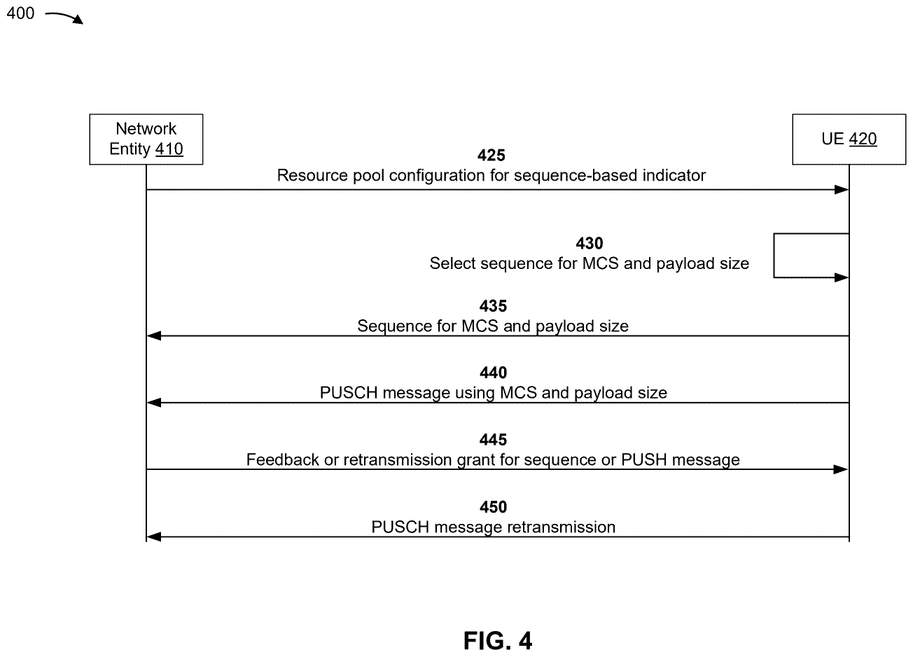

FIG. 4 is a diagram illustrating an example 400 of self-scheduled UEs, in accordance with the present disclosure. Example 400 shows a network entity 410 (e.g., network entity 110) and a UE 420 (e.g., UE 120).

In some scenarios, a network entity may configure a resource pool instead of a per-UE configuration. For example, the network entity may configure a resource pool and allocate each resource to multiple UEs (no PRACH is needed). However, the MCS and payload size may vary with multiple overlapping configurations.

According to various aspects described herein, a network entity may configure a resource pool for PUSCH resources and sequences for MCSs and payload sizes, allowing UEs to self-schedule their uplink transmissions based on this configuration. By transmitting sequences that indicate the selected MCS and payload size, and using these sequences to inform the network entity of the PUSCH resources being used, a UE may reduce control signaling overhead, improve resource utilization, and simplify the blind decoding process. Additionally, feedback mechanisms may ensure reliable communication and handle retransmissions when necessary.

In some aspects, a network entity may use a standalone sequence-based indicator to provide a more efficient way for the UE to inform the network entity about the MCS and payload size of their uplink transmissions. The sequence may reduce the control signaling overhead and simplify the blind decoding process at the network entity.

Example 400 shows the use of the sequence to indicate the MCS and payload size. Initially, the network entity 410 may transmit a resource pool configuration for sequence-based indicators, as shown by reference number 425. The resource pool configuration describes the allocation of PUSCH resources and sequences for various MCSs and payload sizes. Upon receiving this configuration, the UE 420 may perform a selection process to select a specific sequence for an MCS and a payload size, as shown by reference number 430. The selected sequence corresponds to the selected MCS and payload size and serves as an indicator for the PUSCH resource that will be used for the subsequent uplink transmission.

As shown by reference number 435, the UE 420 may transmit the sequence that corresponds to the selected MCS and payload size. As shown by reference number 440, the UE 420 may also transmit a PUSCH message using the indicated PUSCH resource and the selected MCS and payload size. There may be a time gap between transmission of the sequence and transmission of the PUSCH message in the PUSCH resource. The sequence serves as an indicator of the PUSCH resource, enabling the network entity 410 to determine the PUSCH resource upon receiving the sequence. Sequence transmission may not need to provide timing (UEs are assumed to be time aligned), and a higher number of sequences can be embedded in sequence resource pool, as compared to a 2-step random access channel (RACH) procedure. The UE 420 may select the PUSCH resource based at least in part on the sequence.

In some aspects, the UE 420 may select a group of sequences based at least in part on MCS and payload information and then select a random sequence from the group of sequences to transmit. Code division multiplexing (CDM) sequences may be allocated to the same MCS and payload size, ensuring that sequences corresponding to the same targeted uplink power are assigned to the same time and frequency resources. The selection of the sequence by the UE 420 may also be influenced by the target uplink power.

Following the transmission of the sequence and the PUSCH message, the network entity 410 may provide feedback or a retransmission grant to the UE 420, as shown by reference number 445. The feedback transmitted by the network entity 410 includes various acknowledgments (ACKs) or negative acknowledgments (NACKs) correlated with the decoding success of the sequence and data. This feedback may include information acknowledging successful decoding of the sequence and data, or may include a NACK based on unsuccessful decoding. Feedback can be received in various forms, such as in DCI scrambled by a UE identifier (ID) or group common DCI (GC-DCI) with a UE ID in the payload.

If the feedback indicates a NACK or if a retransmission grant is received, the UE 420 may proceed to retransmit the PUSCH message or the sequence based at least in part on the feedback, as shown by reference number 450.

In an example, if the network entity 410 successfully decodes both a sequence and data (e.g., PUSCH message), the network entity 410 may transmit a UE-specific ACK to the UE 420 through one of multiple alternatives. In one alternative, the network entity 410 may transmit a GC-DCI with the payload being ACK/NACK (A/N) bits corresponding to a resource ID. Each bit in the GC-DCI may correspond to a single resource ID in a PUSCH resource pool. In another alternative, the network entity 410 may transmit a special DCI scrambled by a UE ID (e.g., cell radio network temporary identifier (C-RNTI)) or transmit a GC-DCI with the UE ID in the payload. Instead of a full UE ID, the network entity 410 may use a hashed version of the UE ID to reduce the payload.

In another example, if the network entity 410 successfully decodes a sequence but not the data, the network entity 410 may inform the user through one of multiple alternatives. In one alternative, the network entity 410 may transmit a NACK using GC-DCI with the payload being NACK bits corresponding to resource ID. A sequence may correspond to a resource ID in a PUSCH resource pool. This alternative may be used in combination with an alternative in the previous example. If the UE 420 does not know if the sequence is successfully decoded at the network entity 410, the UE 420 may retransmit the sequence and the data with a power ramp in the next resource pool.

In another alternative of this example, the network entity 410 may transmit an ACK using the GC-DCI that indicates that the sequence is decoded and that the data is not decoded. The network entity 410 may indicate an ACK for the sequence through a separate GC-DCI with the payload being A/N bits corresponding to a sequence ID, or the network entity 410 may indicate the list of sequence IDs for which the sequence is decoded but not the data. If the UE 420 has information that the sequence is decoded but not the data, the UE 420 may retransmit the sequence and the data without a power ramp in the next resource pool. Another alternative of the example may include the network entity 410 providing a retransmission grant to the UE 420 using DCI. The network entity 410 may scramble the DCI using a sequence ID, or the network entity 410 may indicate a sequence ID in payload of the DCI (similar to msg2 in PRACH). The retransmission grant may imply a NACK for the data. The UE 420 may retransmit the data in the allocated retransmission grant.

In an additional example, if the network entity 410 does not successfully decode both the sequence and the data, the network entity 410 may follow one of multiple alternatives. In one alternative, the network entity 410 may transmit a NACK using the GC-DCI with a payload being NACK bits corresponding to a resource ID. In another alternative, the network entity 410 may transmit a NACK indicating that the sequence is not decoded. The network entity 410 may transmit the NACK through a separate GC-DCI with the payload being A/N bits corresponding to the sequence ID. This NACK may be transmitted in combination with other alternatives provided in previous examples. In yet another alternative, the network entity 410 may not transmit any DCI corresponding to the resource or the sequence. The UE 420 may retransmit the sequence and the data with a predefined power ramp in the next resource pool.

By allowing UEs to self-schedule their uplink transmissions using a standalone sequence-based indicator, the network entity 410 can significantly reduce the amount of control signaling required. The network entity 410 can use the transmitted sequences to directly decode the PUSCH messages, reducing the complexity and computational load associated with blind decoding. The aspects described herein allow for more flexible and efficient use of PUSCH resources, as UEs can dynamically select resources based on their current MCS and payload requirements. The use of sequences helps manage collisions and interference by providing a structured way for UEs to indicate their resource usage.

As indicated above, FIG. 4 is provided as an example. Other examples may differ from what is described with regard to FIG. 4.

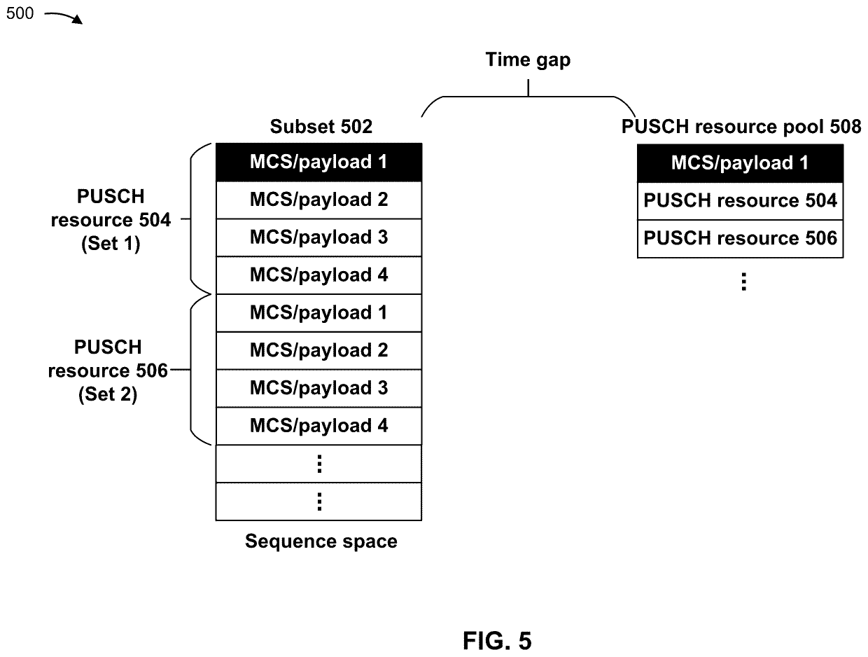

FIG. 5 is a diagram illustrating an example 500 of sequence design, in accordance with the present disclosure.

A sequence-based indicator design may be similar to a 2-step RACH procedure, except that sequence transmission may not provide a timing (UE expects to be time aligned) and there are a higher number of sequences that can be embedded in sequence resource pool as compared to 2-step PRACH. Sequence transmission includes only a few bits of information regarding the MCS and payload size.

A PUSCH resource pool may support variable MCS and payload size combinations. In some aspects, a sequence space may be split or initially divided into multiple sets with each set corresponding to one resource in a PUSCH resource pool. Each set of the sequence space may be further divided into multiple subsets with each subset corresponding to a particular MCS and payload size information.

Example 500 shows a sequence space that comprises different PUSCH resources, such as PUSCH resource 504 and PUSCH resource 506. Each PUSCH resource includes subsets of resources that are designated for sequences corresponding to different MCSs and payload sizes. In this example, the sequence space includes a subset of resources 502 with allocations for various MCS and payload combinations. For PUSCH resource 504, there are sequences allocated for MCS/payload 1, MCS/payload 2, MCS/payload 3, and MCS/payload 4. Similarly, PUSCH resource 506 includes sequences allocated for the same MCS and payload combinations.

The UE 420 may initially select a group of subsets based at least in part on the MCS/payload information, and randomly select a sequence from the group of subsets to transmit. The UE 420 may transmit the sequence. The sequence may point to which resource is being used (associated with the sequence transmission) in the PUSCH pool. The network entity 410 may first decode the sequence and use an MCS, payload, and time/frequency resource information of a PUSCH message to reduce the blind decoding complexity of PUSCH. Also, as the sequence is transmitted before PUSCH transmission, this will help to reduce the excessive buffering at the network entity 410. As sequences do not need to indicate a timing advance (TA), a PUCCH or a scheduling request (SR) waveform, or a codebook (e.g., Zadoff-Chu sequence in PRACH but with a small compressed sensing (CS) separation) may be used for the sequences.

Example 500 also shows a PUSCH resource pool 508 that includes multiple PUSCH resources, such as PUSCH resource 504 and PUSCH resource 506. The UE 420 may transmit a PUSCH message using a PUSCH resource based on the subset that the UE 420 selected for the sequence transmission. There is a time gap between the sequence resource pool (e.g., subset 502) and the PUSCH resource pool 508. If the network entity 410 detected a sequence, the network entity 410 may then determine the location of the PUSCH resource and the MCS/payload information that the UE 420 used in the PUSCH resource pool. Note that there can be one or multiple sequences allocated within a subset (similar to one-to-one or many-to-one mapping in 2-step PRACH). The network entity 410 may provide the sequence allocation to the users as a part of resource pool configuration.

Sequence subsets corresponding to the same MCS/payload may be allocated to the same time/frequency resources. That is, code-division multiplexing (CDM) sequences may be allocated to the same MCS/payload. This is to help CDM sequence detection at the network entity 410. The power variation within CDM sequences can be limited. Sequence subsets may be further divided based at least in part on a targeted uplink power. The UE 420 may determine a targeted uplink power based at least in part on a measured downlink RSRP and the uplink transmit power. The UE 420 may select a sequence based at least in part on the targeted uplink power. Sequences corresponding to the same targeted uplink power may be assigned to the same time/frequency resources. This assignment may help to avoid the near-far impact at the network entity 410.

As indicated above, FIG. 5 is provided as an example. Other examples may differ from what is described with regard to FIG. 5.

FIG. 6 is a diagram illustrating an example process 600 performed, for example, at a UE or an apparatus of a UE. Example process 600 is an example where the apparatus or the UE (e.g., UE 420) performs operations associated with a sequence-based indicator for uplink transmission.

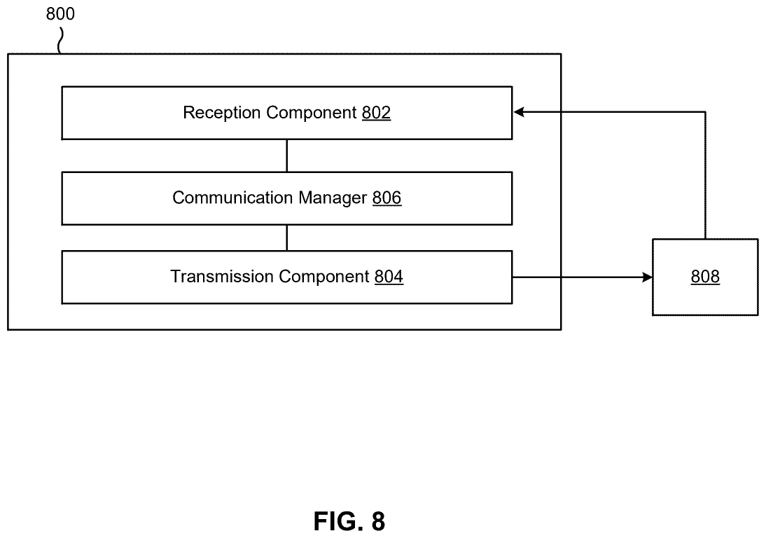

As shown in FIG. 6, in some aspects, process 600 may include receiving a resource pool configuration for PUSCH resources and sequences for MCSs and payload sizes (block 610). For example, the UE (e.g., using reception component 802 or communication manager 806, depicted in FIG. 8) may receive a resource pool configuration for PUSCH resources and sequences for MCSs and payload sizes, as described above.

As further shown in FIG. 6, in some aspects, process 600 may include transmitting a sequence that corresponds to a selected MCS and payload size (block 620). For example, the UE (e.g., using transmission component 804 or communication manager 806, depicted in FIG. 8) may transmit a sequence that corresponds to a selected MCS and payload size, as described above.

As further shown in FIG. 6, in some aspects, process 600 may include transmitting a PUSCH message using a PUSCH resource and the selected MCS and payload size (block 630). For example, the UE (e.g., using transmission component 804 or communication manager 806, depicted in FIG. 8) may transmit a PUSCH message using a PUSCH resource and the selected MCS and payload size, as described above.

Process 600 may include additional aspects, such as any single aspect or any combination of aspects described below or in connection with one or more other processes described elsewhere herein.

In a first aspect, the sequence indicates the PUSCH resource.

In a second aspect, alone or in combination with the first aspect, process 600 includes selecting a group of sequences based at least in part on MCS and payload information, and selecting a random sequence from the group of sequences as the sequence.

In a third aspect, alone or in combination with one or more of the first and second aspects, CDM sequences are allocated to a same MCS and payload size.

In a fourth aspect, alone or in combination with one or more of the first through third aspects, process 600 includes selecting the sequence further based at least in part on a target uplink power.

In a fifth aspect, alone or in combination with one or more of the first through fourth aspects, sequences corresponding to a same targeted uplink power are assigned to a same time and frequency resource.

In a sixth aspect, alone or in combination with one or more of the first through fifth aspects, process 600 includes receiving GC-DCI with a payload that includes feedback for the sequence, where the payload corresponds to a resource identifier.

In a seventh aspect, alone or in combination with one or more of the first through sixth aspects, process 600 includes receiving feedback for the sequence in DCI scrambled by a UE ID.

In an eighth aspect, alone or in combination with one or more of the first through seventh aspects, process 600 includes receiving feedback for the sequence in GC-DCI with a UE identifier in a payload.

In a ninth aspect, alone or in combination with one or more of the first through eighth aspects, process 600 includes receiving feedback for the PUSCH message.

In a tenth aspect, alone or in combination with one or more of the first through ninth aspects, process 600 includes retransmitting the PUSCH message or the sequence based at least in part on negative feedback or a retransmission grant.

In an eleventh aspect, alone or in combination with one or more of the first through tenth aspects, process 600 includes selecting the PUSCH resource based at least in part on the sequence.

Although FIG. 6 shows example blocks of process 600, in some aspects, process 600 may include additional blocks, fewer blocks, different blocks, or differently arranged blocks than those depicted in FIG. 6. Additionally, or alternatively, two or more of the blocks of process 600 may be performed in parallel.

FIG. 7 is a diagram illustrating an example process 700 performed, for example, at a network entity or an apparatus of a network entity. Example process 700 is an example where the apparatus or the network entity (e.g., network entity 410) performs operations associated with a sequence-based indicator for uplink transmission.

As shown in FIG. 7, in some aspects, process 700 may include transmitting a resource pool configuration for PUSCH resources and sequences for MCSs and payload sizes (block 710). For example, the network entity (e.g., using transmission component 904 or communication manager 906, depicted in FIG. 9) may transmit a resource pool configuration for PUSCH resources and sequences for MCSs and payload sizes, as described above.

As further shown in FIG. 7, in some aspects, process 700 may include receiving a sequence that corresponds to a selected MCS and payload size (block 720). For example, the network entity (e.g., using reception component 902 or communication manager 906, depicted in FIG. 9) may receive a sequence that corresponds to a selected MCS and payload size, as described above.

As further shown in FIG. 7, in some aspects, process 700 may include receiving, based at least in part on the sequence, a PUSCH message using the selected MCS and payload size (block 730). For example, the network entity (e.g., using reception component 902 or communication manager 906, depicted in FIG. 9) may receive, based at least in part on the sequence, a PUSCH message using the selected MCS and payload size, as described above.

Process 700 may include additional aspects, such as any single aspect or any combination of aspects described below or in connection with one or more other processes described elsewhere herein.

In a first aspect, the sequence indicates the PUSCH resource, and receiving the PUSCH message includes receiving the PUSCH message in the PUSCH resource.

In a second aspect, alone or in combination with the first aspect, process 700 includes transmitting GC-DCI with a payload that includes feedback that acknowledges a successful decoding of the sequence and data, where the payload corresponds to a resource identifier.

In a third aspect, alone or in combination with one or more of the first and second aspects, process 700 includes transmitting feedback, which acknowledges a successful decoding of the sequence and data, in DCI scrambled by a UE ID.

In a fourth aspect, alone or in combination with one or more of the first through third aspects, process 700 includes transmitting feedback, which acknowledges a successful decoding of the sequence and data, in GC-DCI with a UE ID in a payload.

In a fifth aspect, alone or in combination with one or more of the first through fourth aspects, process 700 includes transmitting GC-DCI with a payload that includes feedback that includes a negative acknowledgement based at least in part on a successful decoding of the sequence and an unsuccessful decoding of data, where the payload corresponds to a resource identifier.

In a sixth aspect, alone or in combination with one or more of the first through fifth aspects, process 700 includes transmitting GC-DCI with a payload that includes feedback that acknowledges a successful decoding of the sequence with an unsuccessful decoding of data.

In a seventh aspect, alone or in combination with one or more of the first through sixth aspects, process 700 includes transmitting a retransmission grant in DCI based at least in part on a successful decoding of the sequence and an unsuccessful decoding of data.

In an eighth aspect, alone or in combination with one or more of the first through seventh aspects, process 700 includes transmitting GC-DCI with a payload that includes feedback that negatively acknowledges an unsuccessful decoding of the sequence and data, where the payload corresponds to a resource ID.

In a ninth aspect, alone or in combination with one or more of the first through eighth aspects, process 700 includes transmitting GC-DCI with a payload that includes feedback that negatively acknowledges an unsuccessful decoding of the sequence and data.

In a tenth aspect, alone or in combination with one or more of the first through ninth aspects, process 700 includes refraining from transmitting DCI that includes feedback for an unsuccessful decoding of the sequence and data.

Although FIG. 7 shows example blocks of process 700, in some aspects, process 700 may include additional blocks, fewer blocks, different blocks, or differently arranged blocks than those depicted in FIG. 7. Additionally, or alternatively, two or more of the blocks of process 700 may be performed in parallel.

FIG. 8 is a diagram of an example apparatus 800 for wireless communication. The apparatus 800 may be a UE, or a UE may include the apparatus 800. In some aspects, the apparatus 800 includes a reception component 802, a transmission component 804, or a communication manager 806, which may be in communication with one another (for example, via one or more buses or one or more other components). In some aspects, the communication manager 806 is the communication manager 150 described in connection with FIG. 1. As shown, the apparatus 800 may communicate with another apparatus 808, such as a UE or a network node (such as a CU, a DU, an RU, or a base station), using the reception component 802 and the transmission component 804. The communication manager 806 may be included in, or implemented via, a processing system (for example, the processing system 140 described in connection with FIG. 1) of the UE.

In some aspects, the apparatus 800 may be configured to perform one or more operations described herein in connection with FIGS. 1-5. Additionally, or alternatively, the apparatus 800 may be configured to perform one or more processes described herein, such as process 600 of FIG. 6. In some aspects, the apparatus 800 or one or more components shown in FIG. 8 may include one or more components of the UE described in connection with FIG. 1. Additionally, or alternatively, one or more components shown in FIG. 8 may be implemented within one or more components described in connection with FIG. 1. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 802 may receive communications, such as reference signals, control information, data communications, or a combination thereof, from the apparatus 808. The reception component 802 may provide received communications to one or more other components of the apparatus 800. In some aspects, the reception component 802 may perform signal processing on the received communications, and may provide the processed signals to the one or more other components of the apparatus 800. In some aspects, the reception component 802 may include one or more components of the UE described above in connection with FIG. 1, such as a radio, one or more RF chains, one or more transceivers, or one or more modems, each of which may in turn be coupled with one or more antennas of the UE.

The transmission component 804 may transmit communications, such as reference signals, control information, data communications, or a combination thereof, to the apparatus 808. In some aspects, one or more other components of the apparatus 800 may generate communications and may provide the generated communications to the transmission component 804 for transmission to the apparatus 808. In some aspects, the transmission component 804 may perform signal processing on the generated communications, and may transmit the processed signals to the apparatus 808. In some aspects, the transmission component 804 may include one or more components of the UE described above in connection with FIG. 1, such as a radio, one or more RF chains, one or more transceivers, or one or more modems, each of which may in turn be coupled with one or more antennas of the UE described in connection with FIG. 1. In some aspects, the transmission component 804 may be co-located with the reception component 802.

The communication manager 806 may support operations of the reception component 802 or the transmission component 804. For example, the communication manager 806 may receive information associated with configuring reception of communications by the reception component 802 or transmission of communications by the transmission component 804. Additionally, or alternatively, the communication manager 806 may generate or provide control information to the reception component 802 or the transmission component 804 to control reception or transmission of communications.

The reception component 802 may receive a resource pool configuration for PUSCH resources and sequences for MCSs and payload sizes. The transmission component 804 may transmit a sequence that corresponds to a selected MCS and payload size. The transmission component 804 may transmit a PUSCH message using a PUSCH resource and the selected MCS and payload size.

The communication manager 806 may select a group of sequences based at least in part on MCS and payload information. The communication manager 806 may select a random sequence from the group of sequences as the sequence. The communication manager 806 may select the sequence further based at least in part on a target uplink power.

The reception component 802 may receive GC-DCI with a payload that includes feedback for the sequence, where the payload corresponds to a resource identifier. The reception component 802 may receive feedback for the sequence in downlink control DCI. The reception component 802 may receive feedback for the sequence in GC-DCI with a UE ID in a payload.

The reception component 802 may receive feedback for the PUSCH message. The transmission component 804 may retransmit the PUSCH message or the sequence based at least in part on negative feedback or a retransmission grant.

The number and arrangement of components shown in FIG. 8 are provided as an example. In practice, there may be additional components, fewer components, different components, or differently arranged components than those shown in FIG. 8. Furthermore, two or more components shown in FIG. 8 may be implemented within a single component, or a single component shown in FIG. 8 may be implemented as multiple, distributed components. Additionally, or alternatively, a set of (one or more) components shown in FIG. 8 may perform one or more functions described as being performed by another set of components shown in FIG. 8.

FIG. 9 is a diagram of an example apparatus 900 for wireless communication. The apparatus 900 may be a network entity, or a network entity may include the apparatus 900. In some aspects, the apparatus 900 includes a reception component 902, a transmission component 904, or a communication manager 906, which may be in communication with one another (for example, via one or more buses or one or more other components). In some aspects, the communication manager 906 is the communication manager 155 described in connection with FIG. 1. As shown, the apparatus 900 may communicate with another apparatus 908, such as a UE or a network node (such as a CU, a DU, an RU, or a base station), using the reception component 902 and the transmission component 904. The communication manager 906 may be included in, or implemented via, a processing system (for example, the processing system 45 described in connection with FIG. 1) of the network entity.

In some aspects, the apparatus 900 may be configured to perform one or more operations described herein in connection with FIGS. 1-5. Additionally, or alternatively, the apparatus 900 may be configured to perform one or more processes described herein, such as process 700 of FIG. 7. In some aspects, the apparatus 900 or one or more components shown in FIG. 9 may include one or more components of the network entity described in connection with FIG. 1. Additionally, or alternatively, one or more components shown in FIG. 9 may be implemented within one or more components described in connection with FIG. 1. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 902 may receive communications, such as reference signals, control information, data communications, or a combination thereof, from the apparatus 908. The reception component 902 may provide received communications to one or more other components of the apparatus 900. In some aspects, the reception component 902 may perform signal processing on the received communications, and may provide the processed signals to the one or more other components of the apparatus 900. In some aspects, the reception component 902 may include one or more components of the network entity described above in connection with FIG. 1, such as a radio, one or more RF chains, one or more transceivers, or one or more modems, each of which may in turn be coupled with one or more antennas of the network entity.

The transmission component 904 may transmit communications, such as reference signals, control information, data communications, or a combination thereof, to the apparatus 908. In some aspects, one or more other components of the apparatus 900 may generate communications and may provide the generated communications to the transmission component 904 for transmission to the apparatus 908. In some aspects, the transmission component 904 may perform signal processing on the generated communications, and may transmit the processed signals to the apparatus 908. In some aspects, the transmission component 904 may include one or more components of the network entity described above in connection with FIG. 1, such as a radio, one or more RF chains, one or more transceivers, or one or more modems, each of which may in turn be coupled with one or more antennas of the network entity described in connection with FIG. 1. In some aspects, the transmission component 904 may be co-located with the reception component 902.

The communication manager 906 may support operations of the reception component 902 or the transmission component 904. For example, the communication manager 906 may receive information associated with configuring reception of communications by the reception component 902 or transmission of communications by the transmission component 904. Additionally, or alternatively, the communication manager 906 may generate or provide control information to the reception component 902 or the transmission component 904 to control reception or transmission of communications.

The transmission component 904 may transmit a resource pool configuration for PUSCH resources and sequences for MCSs and payload sizes. The reception component 902 may receive a sequence that corresponds to a selected MCS and payload size. The reception component 902 may receive, based at least in part on the sequence, a PUSCH message using the selected MCS and payload size.

The transmission component 904 may transmit GC-DCI with a payload that includes feedback that acknowledges a successful decoding of the sequence and data, where the payload corresponds to a resource identifier.

The transmission component 904 may transmit feedback, which acknowledges a successful decoding of the sequence and data, in DCI scrambled by a UE ID. The transmission component 904 may transmit feedback, which acknowledges a successful decoding of the sequence and data, in GC-DCI with a UE ID in a payload.

The transmission component 904 may transmit GC-DCI with a payload that includes feedback that includes a NACK based at least in part on a successful decoding of the sequence and an unsuccessful decoding of data, where the payload corresponds to a resource ID.

The transmission component 904 may transmit GC-DCI with a payload that includes feedback that acknowledges a successful decoding of the sequence with an unsuccessful decoding of data. The transmission component 904 may transmit a retransmission grant in DCI based at least in part on a successful decoding of the sequence and an unsuccessful decoding of data.

The transmission component 904 may transmit GC-DCI with a payload that includes feedback that negatively acknowledges an unsuccessful decoding of the sequence and data, where the payload corresponds to a resource ID. The transmission component 904 may transmit GC-DCI with a payload that includes feedback that negatively acknowledges an unsuccessful decoding of the sequence and data. The communication manager 906 may refrain from transmitting DCI that includes feedback for an unsuccessful decoding of the sequence and data.

The number and arrangement of components shown in FIG. 9 are provided as an example. In practice, there may be additional components, fewer components, different components, or differently arranged components than those shown in FIG. 9. Furthermore, two or more components shown in FIG. 9 may be implemented within a single component, or a single component shown in FIG. 9 may be implemented as multiple, distributed components. Additionally, or alternatively, a set of (one or more) components shown in FIG. 9 may perform one or more functions described as being performed by another set of components shown in FIG. 9.

The following provides an overview of some Aspects of the present disclosure:
Aspect 1: A method of wireless communication performed by a user equipment (UE), comprising: receiving a resource pool configuration for physical uplink shared channel (PUSCH) resources and sequences for modulation and coding schemes (MCSs) and payload sizes; transmitting a sequence that corresponds to a selected MCS and payload size; and transmitting a PUSCH message using a PUSCH resource and the selected MCS and payload size.
Aspect 2: The method of Aspect 1, wherein the sequence indicates the PUSCH resource.
Aspect 3: The method of any of Aspects 1-2, further comprising: selecting a group of sequences based at least in part on MCS and payload information; and selecting a random sequence from the group of sequences as the sequence.
Aspect 4: The method of any of Aspects 1-3, wherein code division multiplexing sequences are allocated to a same MCS and payload size.
Aspect 5: The method of any of Aspects 1-4, further comprising selecting the sequence further based at least in part on a target uplink power.
Aspect 6: The method of Aspect 5, wherein sequences corresponding to a same targeted uplink power are assigned to a same time and frequency resource.
Aspect 7: The method of any of Aspects 1-6, further comprising receiving group common downlink control information with a payload that includes feedback for the sequence, wherein the payload corresponds to a resource identifier.
Aspect 8: The method of any of Aspects 1-7, further comprising receiving feedback for the sequence in downlink control information scrambled by a UE identifier.
Aspect 9: The method of any of Aspects 1-8, further comprising receiving feedback for the sequence in group common downlink control information with a UE identifier in a payload.
Aspect 10: The method of any of Aspects 1-9, further comprising receiving feedback for the PUSCH message.
Aspect 11: The method of any of Aspects 1-10, further comprising retransmitting the PUSCH message or the sequence based at least in part on negative feedback or a retransmission grant.
Aspect 12: The method of any of Aspects 1-11, further comprising selecting the PUSCH resource based at least in part on the sequence.
Aspect 13: A method of wireless communication performed by a network entity, comprising: transmitting a resource pool configuration for physical uplink shared channel (PUSCH) resources and sequences for modulation and coding schemes (MCSs) and payload sizes; receiving a sequence that corresponds to a selected MCS and payload size; and receiving, based at least in part on the sequence, a PUSCH message using the selected MCS and payload size.
Aspect 14: The method of Aspect 13, wherein the sequence indicates the PUSCH resource, and wherein receiving the PUSCH message includes receiving the PUSCH message in the PUSCH resource.
Aspect 15: The method of any of Aspects 13-14, further comprising transmitting group common downlink control information with a payload that includes feedback that acknowledges a successful decoding of the sequence and data, wherein the payload corresponds to a resource identifier.
Aspect 16: The method of any of Aspects 13-15, further comprising transmitting feedback, which acknowledges a successful decoding of the sequence and data, in downlink control information scrambled by a user equipment identifier.
Aspect 17: The method of any of Aspects 13-16, further comprising transmitting feedback, which acknowledges a successful decoding of the sequence and data, in group common downlink control information with a user equipment identifier in a payload.
Aspect 18: The method of any of Aspects 13-16, further comprising transmitting group common downlink control information with a payload that includes feedback that includes a negative acknowledgement based at least in part on a successful decoding of the sequence and an unsuccessful decoding of data, wherein the payload corresponds to a resource identifier.
Aspect 19: The method of any of Aspects 13-16, further comprising transmitting group common downlink control information with a payload that includes feedback that acknowledges a successful decoding of the sequence with an unsuccessful decoding of data.
Aspect 20: The method of any of Aspects 13-16, further comprising transmitting a retransmission grant in downlink control information based at least in part on a successful decoding of the sequence and an unsuccessful decoding of data.
Aspect 21: The method of any of Aspects 13-16, further comprising transmitting group common downlink control information with a payload that includes feedback that negatively acknowledges an unsuccessful decoding of the sequence and data, wherein the payload corresponds to a resource identifier.
Aspect 22: The method of any of Aspects 13-16, further comprising transmitting group common downlink control information with a payload that includes feedback that negatively acknowledges an unsuccessful decoding of the sequence and data.
Aspect 23: The method of any of Aspects 13-15, further comprising refraining from transmitting downlink control information that includes feedback for an unsuccessful decoding of the sequence and data.
Aspect 24: An apparatus for wireless communication at a device, the apparatus comprising one or more processors; one or more memories coupled with the one or more processors; and instructions stored in the one or more memories and executable by the one or more processors to cause the apparatus to perform the method of one or more of Aspects 1-23.
Aspect 25: An apparatus for wireless communication at a device, the apparatus comprising one or more memories and one or more processors coupled to the one or more memories, the one or more processors configured to cause the device to perform the method of one or more of Aspects 1-23.
Aspect 26: An apparatus for wireless communication, the apparatus comprising at least one means for performing the method of one or more of Aspects 1-23.
Aspect 27: A non-transitory computer-readable medium storing code for wireless communication, the code comprising instructions executable by one or more processors to perform the method of one or more of Aspects 1-23.
Aspect 28: A non-transitory computer-readable medium storing a set of instructions for wireless communication, the set of instructions comprising one or more instructions that, when executed by one or more processors of a device, cause the device to perform the method of one or more of Aspects 1-23.
Aspect 29: A device for wireless communication, the device comprising a processing system that includes one or more processors and one or more memories coupled with the one or more processors, the processing system configured to cause the device to perform the method of one or more of Aspects 1-23.
Aspect 30: An apparatus for wireless communication at a device, the apparatus comprising one or more memories and one or more processors coupled to the one or more memories, the one or more processors individually or collectively configured to cause the device to perform the method of one or more of Aspects 1-23.
Aspect 31: A device comprising a processing system that includes one or more processors and one or more code-storing memories coupled with the one or more processors, the processing system configured to cause the device to perform the method of one or more of Aspects 1-23.
Aspect 32: A device comprising a processing system that includes processor circuitry and code-storing memory circuitry, the processing system configured to cause the device to perform the method of one or more of Aspects 1-23.

It will be apparent that systems or methods described herein may be implemented in different forms of hardware or a combination of hardware and software. A component being configured to perform a function means that the component has a capability to perform the function, and does not require the function to be actually performed by the component, unless noted otherwise.

As used herein, the term “determine” or “determining” can encompass one or more of a wide variety of actions. For example, “determining” can include one or more of calculating, computing, processing, deriving, detecting, estimating, investigating, looking up, inferring, ascertaining, measuring, resolving, selecting, choosing, obtaining, identifying, interpreting, demodulating, decoding, reading, establishing, forming or generating, among other examples. In some such examples, determining can involve a processor performing some type of calculating, computing, deriving, estimating, inferring, ascertaining, resolving, predicting or other processing to obtain one or more numerical values, sets, elements or other information or results. In some other such examples, determining can involve a processor identifying, looking up, investigating or otherwise obtaining some type of value, set, element or other information or result from a table, a data structure, a database or other memory device or location. In some other such examples, determining can involve a processor identifying, interpreting, demodulating, decoding, detecting, reading or otherwise obtaining some type of value, set, element or other information or result signaled in, for example, a received wireless packet. In some other such examples, determining can involve a processor selecting or choosing one or more values, sets, elements or other information or results from a larger set of values, sets elements or other information or results. In some other such examples, determining can involve a processor performing a measurement, such as on a received signal.

As used herein, the articles “a” and “an” are intended to refer to one or more items and may be used interchangeably with “one or more” or “at least one.” As used herein, a phrase referring to “at least one of” or “one or more of” a list of items refers to any combination of those items, including single members. As an example, “at least one of: a, b, or c” is intended to cover: a, b, c, a-b, a-c, b-c, and a-b-c. Additionally, as used herein, a phrase referring to “a” or “an” element refers to one or more of such elements acting individually or collectively to perform the recited function(s). Additionally, as used herein, a “set” can refer to one or more items, and a “subset” can refer to a whole set or less than the whole set, but not an empty set. “Set,” “group,” and similar terms are intended to include one or more items and may be used interchangeably with “one or more.” Furthermore, as used herein, the term “or” is intended to be interpreted in the inclusive sense (such as when referring to a series) and may be used interchangeably with “and/or,” unless otherwise explicitly indicated (for example, if used in conjunction with “either” or “only one of”). For example, “A or B” may include A only, B only, or a combination of A and B. Also, as used herein, the terms “has,” “have,” “having,” “comprise,” “comprising,” “include” and “including,” and derivatives thereof or similar terms are intended to be open-ended terms that do not limit an element that they modify (for example, an element “having” A also may have B).

As used herein, the phrase “associated with” is intended to be interpreted in the inclusive sense, unless otherwise explicitly indicated. For example, the phrase “associated with” is not to be construed as a reference to a closed set of conditions, factors, criteria, elements, components, or actions, among other examples. Specifically, unless a phrase refers to “associated with only ‘a,’” or the equivalent in context, whatever it is that is “associated with ‘a,’” may be associated with “a” alone or associated with a combination of “a” and one or more other conditions, factors, criteria, elements, components, or actions, among other examples. In various examples, the phrase “associated with” may be interpreted to mean “in association with,” “in accordance with,” “based on,” “based at least in part on,” “as a function of,” “in response to,” “responsive to,” or “using” as appropriate in the relevant context unless otherwise explicitly indicated. Furthermore, what follows the phrase “associated with,” “in association with,” “in accordance with,” “based on,” “based at least in part on,” “as a function of,” “in response to,” “responsive to,” or “using” is not necessarily the focal point or primary factor associated with the limitation preceding the phrase.

As used herein, “satisfying a threshold” may, depending on the context, refer to a value being greater than the threshold, greater than or equal to the threshold, less than the threshold, less than or equal to the threshold, equal to the threshold, or not equal to the threshold, among other examples.

Even though particular combinations of features are recited in the claims or disclosed in the specification, these combinations are not intended to limit the scope of all aspects described herein. Many of these features may be combined in ways not specifically recited in the claims or disclosed in the specification. The disclosure of various aspects includes each dependent claim in combination with every other claim in the claim set.

What is claimed is:

1. A user equipment (UE), comprising:
a processing system that includes one or more processors and one or more code-storing memories coupled with the one or more processors, the processing system configured to cause the UE to:
receive a resource pool configuration for physical uplink shared channel (PUSCH) resources and sequences for modulation and coding schemes (MCSs) and payload sizes;
transmit a sequence that corresponds to a selected MCS and payload size; and
transmit a PUSCH message using a PUSCH resource and the selected MCS and payload size.

2. The UE of claim 1, wherein the sequence indicates the PUSCH resource.

3. The UE of claim 1, wherein the processing system is configured to cause the UE to select the PUSCH resource based at least in part on the sequence.

4. The UE of claim 1, wherein the processing system is configured to cause the UE to:
select a group of sequences based at least in part on MCS and payload information; and
select a random sequence from the group of sequences as the sequence.

5. The UE of claim 1, wherein code division multiplexing sequences are allocated to a same MCS and payload size.

6. The UE of claim 1, wherein the processing system is configured to cause the UE to select the sequence further based at least in part on a target uplink power.

7. The UE of claim 6, wherein sequences corresponding to a same targeted uplink power are assigned to a same time and frequency resource.

8. The UE of claim 1, wherein the processing system is configured to cause the UE to receive group common downlink control information with a payload that includes feedback for the sequence, wherein the payload corresponds to a resource identifier.

9. The UE of claim 1, wherein the processing system is configured to cause the UE to receive feedback for the sequence in downlink control information scrambled by a UE identifier.

10. The UE of claim 1, wherein the processing system is configured to cause the UE to receive feedback for the sequence in group common downlink control information with a UE identifier in a payload or for the PUSCH message.

11. The UE of claim 1, wherein the processing system is configured to cause the UE to retransmit the PUSCH message or the sequence based at least in part on negative feedback or a retransmission grant.

12. A network entity, comprising:
a processing system that includes one or more processors and one or more code-storing memories coupled with the one or more processors, the processing system configured to cause the network entity to:
transmit a resource pool configuration for physical uplink shared channel (PUSCH) resources and sequences for modulation and coding schemes (MCSs) and payload sizes;
receive a sequence that corresponds to a selected MCS and payload size; and
receive, based at least in part on the sequence, a PUSCH message using the selected MCS and payload size.

13. The network entity of claim 12, wherein the processing system is configured to cause the network entity to transmit group common downlink control information with a payload that includes feedback that acknowledges a successful decoding of the sequence and data, wherein the payload corresponds to a resource identifier.

14. The network entity of claim 12, wherein the processing system is configured to cause the network entity to transmit feedback, which acknowledges a successful decoding of the sequence and data, in downlink control information (DCI) scrambled by a user equipment (UE) identifier (ID) or in group common DCI with the UE ID in a payload.

15. The network entity of claim 12, wherein the processing system is configured to cause the network entity to transmit group common downlink control information with a payload that includes feedback that includes a negative acknowledgement based at least in part on a successful decoding of the sequence and an unsuccessful decoding of data, wherein the payload corresponds to a resource identifier.

16. The network entity of claim 12, wherein the processing system is configured to cause the network entity to transmit group common downlink control information with a payload that includes feedback that acknowledges a successful decoding of the sequence with an unsuccessful decoding of data.

17. The network entity of claim 12, wherein the processing system is configured to cause the network entity to transmit a retransmission grant in downlink control information based at least in part on a successful decoding of the sequence and an unsuccessful decoding of data.

18. The network entity of claim 12, wherein the processing system is configured to cause the network entity to transmit group common downlink control information with a payload that includes feedback that negatively acknowledges an unsuccessful decoding of the sequence and data, wherein the payload corresponds to a resource identifier.

19. The network entity of claim 12, wherein the processing system is configured to cause the network entity to transmit group common downlink control information with a payload that includes feedback that negatively acknowledges an unsuccessful decoding of the sequence and data.

20. The network entity of claim 12, wherein the processing system is configured to cause the network entity to refrain from transmitting downlink control information that includes feedback for an unsuccessful decoding of the sequence and data.
